(19) United States
(12) Patent Application Publication
(10) Pub. No.: US 2009/0316576 A1
(43) Pub. Date: Dec. 24, 2009

(54) ADDRESS-SIMULATION DEVICE AND METHOD THEREOF

(76) Inventor: Yu-Chang CHANG, Taipei City (TW)

Correspondence Address: Chih Feng Yeh;BRIAN M. MCINNIS, 12th Floor, Ruttonjee House, 11 Duddell Street, Hong Kong, HK

(21) Appl. No.: 12/211,350

(22) Filed: Sep. 16, 2008

(30) Foreign Application Priority Data
Jun. 24, 2008 (TW) 97123565

(51) Int. Cl. H04L 12/26; H04L 12/56

(52) U.S. Cl. 370/229; 370/389

(57) ABSTRACT

An address-simulation device is disclosed. The address-simulation device includes an address-generating element, a header-filling element, a packet-generating element and a packet-transmitting element. The address-generating element generates a plurality of addresses, wherein each of the addresses is different from the others. The header-filling element fills the addresses respectively in a plurality of headers. The packet-generating element combines the headers with data respectively to form a plurality of packets. The packet-transmitting element transmits the packets to a server. An address-simulation method is also disclosed.

### RELATED APPLICATIONS

This application claims priority to Taiwan Application Serial Number 97123565, filed Jun. 24, 2008, which is herein incorporated by reference.

### BACKGROUND

1. Field of Invention

The present invention relates to a network device and a method thereof. More particularly, the present invention relates to an address-simulation device and a method thereof.

2. Description of Related Art

A distributed denial of service attack (DDoS) occurs when several network devices flood the bandwidth or resources of a targeted system, usually one or more web servers. Furthermore, every network device can only utilize an IP (Internet Protocol) address and a MAC (media control access) address at the same time in the present network architecture (such as TCP/IP). Therefore, many network devices are needed to simulate a DdoS attack to test severs. However, the number of the network devices would limit the simulated DdoS attack.

Above all, an address-simulation device and method thereof is needed to simulate many network devices utilizing a few network devices.

### SUMMARY

According to one embodiment of this invention, an address-simulation device includes an address-generating element, a header-filling element, a packet-generating element and a packet-transmitting element. The address-generating element generates several addresses, wherein each of the addresses is different from the others. The header-filling element fills the addresses respectively in several headers. The packet-generating element combines the headers with data respectively to form several packets. The packet-transmitting element transmits the packets to a server.

According to another embodiment of this invention, an address-simulation method includes the following steps:

(1) Generating several addresses, wherein each of the addresses is different from the others.

(2) Filling the addresses respectively in several headers.

(3) Combining the headers with data respectively to form several packets.

(4) Transmitting the packets to a server.

According to still another embodiment of this invention, an address-simulation device includes an address-generating element, a header-filling element, a packet-generating element and a packet-transmitting element. The address-generating element generates a random address. The header-filling element fills the address in a header. The packet-generating element combines the header with data to form a packet. The packet-transmitting element transmits the packet to a server.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a block diagram of an address-simulation device according to one embodiment of this invention;

FIG. 2 illustrates a block diagram of the address-generating element in FIG. 1;

FIG. 3 is a flow diagram of an address-simulation method according to another embodiment of this invention;

FIG. 4 is a flow diagram of step 302 in FIG. 3; and

FIG. 5 is a flow diagram of generating different addresses according to still another embodiment of the invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

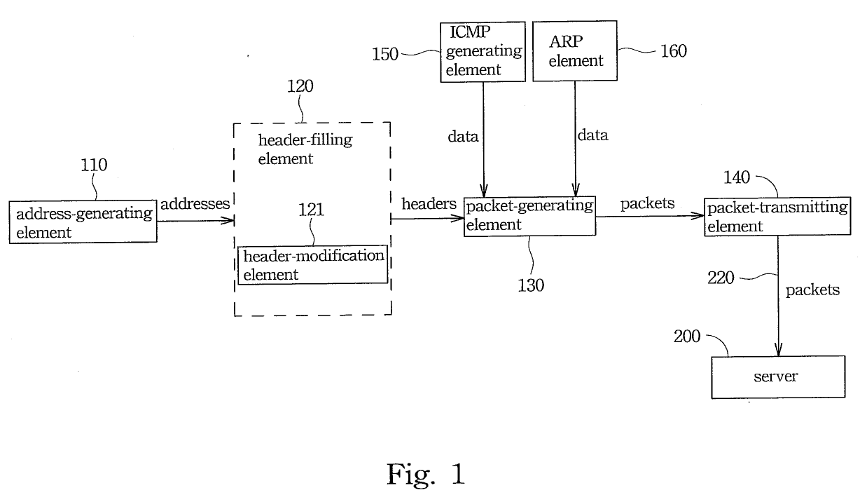

The address-simulation device can generate several packets with different addresses. Therefore, the server regards these packets as packets from several different network devices. FIG. 1 illustrates a block diagram of an address-simulation device according to one embodiment of this invention. Referring to FIG. 1, the address-simulation device includes an address-generating element 110, a header-filling element 120, a packet-generating element 130 and a packet-transmitting element 140. The address-generating element 110 generates several addresses, wherein each of the addresses is different from the others. Since an address represents a network device in the network architecture, the addresses generated by the address-generating element 110 would be taken as the addresses generated by several network devices. The header-filling element 120 fills the addresses respectively in several headers. The packet-generating element 130 combines the headers with data respectively to form several packets. Each header is combined with different data to form the packets. The packet-transmitting element 140 transmits the packets to a server 200. Therefore, the server 200 regards the packets as packets from different network devices according to the addresses of the packets.

In other words, the address-generating element 110 generates a random address. The header-filling element 120 fills the address in the header. The packet-generating element 130 combines the header with data to form a packet. The packet-transmitting element 140 transmits the packet to the server 200. Therefore, the address of the packet generated by the address-simulation device is not fixed. The server 200 may regard packets generated by the address-simulation device as packets generated by different network devices according to the addresses of the packets.

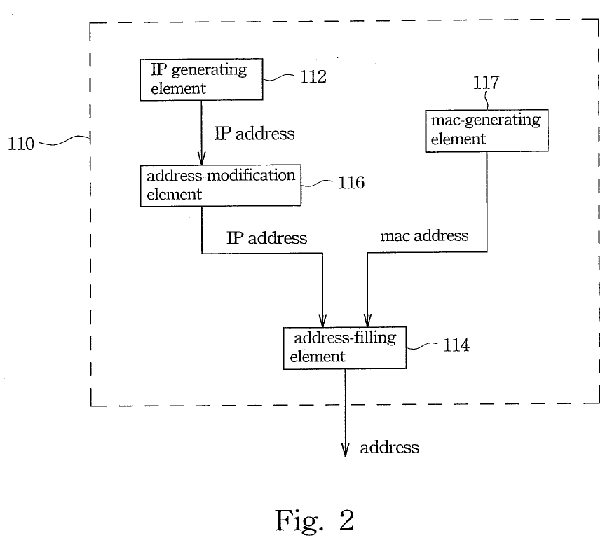

In general, an address of a network device may contain an IP address. Different IP addresses stand for different network devices. Therefore, the address-simulation may simulate several network devices by generating packets with different IP addresses. FIG. 2 illustrates a block diagram of the address-generating element 110 in FIG. 1. Referring to FIG. 2, the address-generating element 110 includes an IP-generating element 112 and an address-filling element 114. The IP-generating element 112 generates several IP addresses, wherein each of the IP addresses is different from the others. The address-filling element 114 fills the IP addresses in the IP address columns of the addresses respectively. Therefore, the address-generating element 110 may generate addresses with different IP addresses.

In other words, the IP-generating element 112 generates a random IP address. The address-filling element 114 fills the IP address in the IP address column of the address. Therefore, the address-generating element 110 may generate an address with an unfixed IP address.

Furthermore, referring to FIG. 1 and FIG. 2, the address-generating element 110 may include an address-modification element 116 for modifying the IP address to make the IP address compatible with a LAN, wherein the server 200 connects to the LAN. Therefore, the IP address generated by the address-generating element 110 can be compatible with the LAN and be transmitted through the LAN after the modification of the address-modification element 116.

An address of a network device may also contain a MAC (media access control) address. Different MAC addresses represent different network devices. Therefore, the address-simulation may simulate several network devices by generating packets with different MAC addresses. Hence, the address-generating element 110 may contain a MAC-generating element 117. The MAC-generating element 117 generates several MAC addresses, wherein each of the MAC addresses is different from the others. In addition, the address-filling element 114 fills the MAC addresses in the MAC address columns of the addresses. Therefore, the address-generating element 110 may generate packets with different MAC addresses.

In other words, the MAC-generating element 117 generates a random MAC address. The address-filling element 114 fills the MAC address in the MAC address column of the address. Therefore, the address-generating element 110 may generate an address with an unfixed MAC address.

In a DdoS attack, an ICMP packet is often used to attack the servers. Therefore, referring to FIG. 1, when the address-simulation device simulates a Ddos attack, the address-simulation device may include an ICMP (Internet Control Message Protocol) generating element 150. The ICMP generating element 150 generates ICMP data as the data. Therefore, the packets with the ICMP data would be ICMP packets.

SYN packets are also often used to attack the server in a Ddos attack. Therefore, referring to FIG. 1, when the address-simulation device simulates a Ddos attack, the header-filling element 120 may include a header-modification element 121. The header-modification element 121 modifies the TCP flags of the headers to make the packets become SYN packets.

ARP (Address Resolution Protocol) packets may cause the server doing further process (such as judging if the network device sending the packets is in the same LAN with the server). Therefore, ARP packets test the server. Referring to FIG. 1, when the address-simulation device utilizes ARP addresses to test the server 200, the address-simulation device may include an ARP element 160. The ARP element 160 generates ARP data to be the data. Therefore, the packets with the ARP data would be ARP packets.

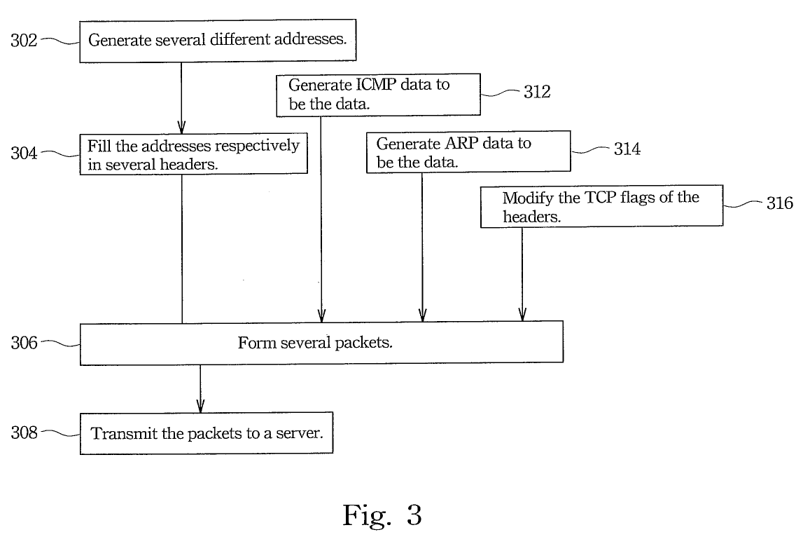

FIG. 3 is a flow diagram of an address-simulation method according to another embodiment of this invention. The address-simulation method generates several packets with different addresses. The address-simulation method includes the following steps:

(1) Generate several different addresses (step 302).

(2) Fill the addresses respectively in several headers (step 304).

(3) Combine the headers with data respectively to form several packets (step 306).

(4) Transmit the packets to a server (step 308).

Therefore, the server regards these packets as packets from different network devices according to different addresses of these packets.

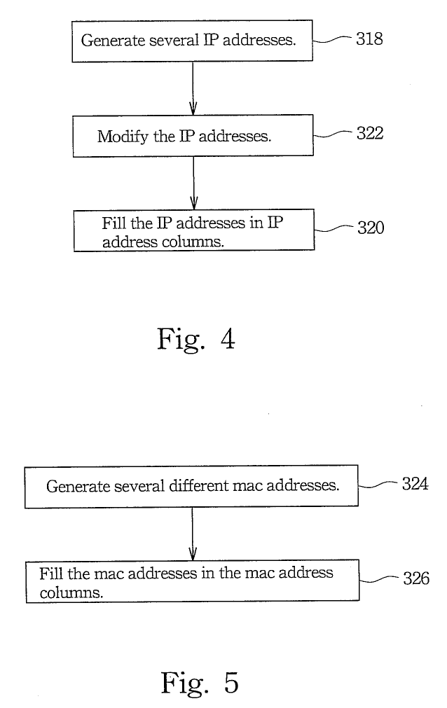

FIG. 4 is a flow diagram of step 302 in FIG. 3. Since different IP addresses stand for different network devices, step 302 may include the following steps:

(1.1) Generate several IP addresses, wherein each of the IP addresses is different from the others (step 318).

(1.2) Fill the IP addresses in IP address columns of the addresses (step 320).

Therefore, the server may regard the packets with different IP addresses as packets from different network devices according to the IP addresses.

Furthermore, step 302 may include:

(1.3) Modify the IP addresses to make the IP addresses compatible with a LAN, wherein the server connects to the LAN (step 322).

Therefore, the server may regard the packets with the modified IP addresses as packets in the same LAN and then process the packets.

FIG. 5 is a flow diagram of generating different addresses according to still another embodiment of the invention. Since different MAC addresses stand for different network devices, generating different addresses may include the following steps:

(1.a) Generate several different MAC addresses (step 324).

(1.b) Fill the MAC addresses in the MAC address columns of the addresses (step 326).

Therefore, the server may regard the packets with different MAC addresses as packets from different network devices according to the MAC addresses.

In addition, when the address-simulation method simulates several network devices to test a server, ICMP packets, ARP packets or SYN packets may be utilized since the server may do further process to these packets.

Therefore, when ICMP packets test the server in the address-simulation method, the address-simulation method may include the step of generating ICMP data to be the data (step 312) before step 306. Hence, the packets would be ICMP packets after combining the headers with the ICMP data.

When ARP packets test the server in the address-simulation method, the address-simulation method may include the step of generating ARP data to be the data (step 314) before step 306. Hence, the packets would be ARP packets after combining the headers with the ARP data.

When SYN packets test the server in the address-simulation method, the address-simulation method may include the step of modifying the TCP flags of the headers to make the packets become SYN packets (step 316) before step 306.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An address-simulation device comprising:
an address-generating element for generating a plurality of addresses, wherein each of the addresses is different from the others;
a header-filling element for filling the addresses respectively in a plurality of headers;
a packet-generating element for combining the headers with data respectively to form a plurality of packets; and
a packet-transmitting element for transmitting the packets to a server.

2. The address-simulation device of claim 1, wherein the address-generating element comprises:
an IP-generating element for generating a plurality of IP (Internet Protocol) addresses, wherein each of the IP addresses is different from the others; and
an address-filling element for filling the IP addresses in the IP address columns of the addresses respectively.

3. The address-simulation device of claim 2, wherein the address-generating element comprises:
an address-modification element for modifying the IP addresses to make the IP addresses compatible with a LAN (Local Area Network), wherein the server connects to the LAN.

4. The address-simulation device of claim 1, wherein the address-generating element comprises:
a MAC-generating element for generating a plurality of MAC (media access control) addresses, wherein each of the MAC addresses is different from the others; and
an address-filling element for filling the MAC addresses in the MAC address columns of the addresses respectively.

5. The address-simulation device of claim 1, further comprising:
an ICMP (Internet Control Message protocol) generating element for generating ICMP data to be the data.

6. The address-simulation device of claim 1, further comprising:
an ARP (Address Revolution Protocol) element for generating ARP data to be the data.

7. The address-simulation device of claim 1, wherein the header-filling element comprises:
a header-modification element for modifying the TCP flags of the headers to make the packets become SYN packets.

8. An address-simulation method comprising:
generating a plurality of addresses, wherein each of the addresses is different from the others;
filling the addresses respectively in a plurality of headers;
combining the headers with data respectively to form a plurality of packets; and
transmitting the packets to a server.

9. The address-simulation method of claim 8, wherein the steps of generating the addresses comprises:
generating a plurality of IP addresses, wherein each of the IP addresses is different from the others; and
filling the IP addresses in the IP address columns of the addresses respectively.

10. The address-simulation method of claim 9, wherein the steps of generating the addresses comprises:
modifying the IP addresses to make the IP addresses compatible with a LAN, wherein the server connects to the LAN.

11. The address-simulation method of claim 8, wherein the steps of generating the addresses comprises:
generating a plurality of MAC addresses, wherein each of the MAC addresses is different from the others; and
filling the MAC addresses in the MAC address columns of the addresses respectively.

12. The address-simulation method of claim 8, further comprising:
generating ICMP data to be the data.

13. The address-simulation method of claim 8, further comprising:
generating ARP data to be the data.

14. The address-simulation method of claim 8, further comprising:
modifying the TCP flags of the headers to make the packets become SYN packets.

15. An address-simulation device comprising:
an address-generating element for generating a random address;
a header-filling element for filling the address in a header;
a packet-generating element for combining the header with data to form a packet; and
a packet-transmitting element for transmitting the packet to a server.

16. The address-simulation device of claim 15, wherein the address-generating element comprises:
an IP-generating element for generating a random IP address;
an address-filling element for filling the IP address in the IP address column of the address; and
an address-modification element for modifying the IP address to make the IP address compatible with a LAN, wherein the server connects to the LAN.

17. The address-simulation device of claim 15, wherein the address-generating element comprises:
a MAC-generating element for generating a random MAC address; and
an address-filling element for filling the MAC address in the MAC address column of the address.

18. The address-simulation device of claim 15, further comprising:
an ICMP (Internet Control Message protocol) generating element for generating ICMP data to be the data.

19. The address-simulation device of claim 15, further comprising:
an ARP (Address Revolution Protocol) element for generating ARP data to be the data.

20. The address-simulation device of claim 15, wherein the header-filling element comprises:
a header-modification element for modifying the TCP flag of the header to make the packet become a SYN packet.
